(19) United States
(12) Patent Application Publication
(10) Pub. No.: US 2015/0242874 A1
(43) Pub. Date: Aug. 27, 2015

(54) SYSTEMS AND METHODS TO GENERATE INCENTIVIZED PEER-TO-PEER SHARING OF DOWNLOAD LINKS FROM WITHIN MOBILE APPLICATION

(71) Applicant: SAAMBAA LLC, San Diego, CA (US)

(72) Inventors: Matthew Voigt, San Diego, CA (US); Ryan Goodman, San Diego, CA (US); Scott Kurth, San Diego, CA (US)

(21) Appl. No.: 14/628,021

(22) Filed: Feb. 20, 2015

Related U.S. Application Data
(60) Provisional application No. 61/943,277, filed on Feb. 21, 2014.

(51) Int. Cl. G06Q 30/02

(52) U.S. Cl. CPC G06Q 30/0214

(57) ABSTRACT

The present disclosure provides a method for incentivizing the sharing of a mobile application, comprising providing, on a user interface of a mobile application executed on a first mobile electronic device of a first user, an offer for a promotion, which promotion is accessible by the first user when the first user elects to share the mobile application with at least one second user having a second mobile electronic device. Next, a request from the first user to share the mobile application with the second user is received, and an electronic communication is directed from the first mobile electronic device to the second user, which electronic communication has an electronic link that enables the second user to download a copy of the mobile application onto the second mobile electronic device. Next, the first user is provided with the promotion.

### CROSS-REFERENCE

This application claims the benefit of U.S. Provisional Application No. 61/943,277, filed Feb. 21, 2014, which application is entirely incorporated herein by reference.

### BACKGROUND

Conventionally, mobile application developers raise the value of their mobile application (“mobile app”) by increasing the number of users who use the mobile application. In order to facilitate growth, it is typical for mobile app developers to rely on paid advertisements to build awareness and generate downloads for their mobile applications. However, paid advertisements can be cost-prohibitive.

Mobile application developers also rely on word-of-mouth marketing to spread awareness of their mobile apps within peer groups. For instance, users of a mobile app can share a download link with friends by email, text-message (“text”) or social network post, which allows friends to easily discover and download the mobile app from an app store without searching for it. This peer-to-peer sharing of mobile application links generates free marketing for the mobile application developer. However, peer-to-peer sharing of mobile app links may not occur without sufficient motivation to encourage sharing.

According to a recent report by Gartner, there are over 1.9 million apps now available in the app stores, and most mobile apps have far less than 50,000 downloads. Therefore, there is a significant need to provide improved methods of incentivized, peer-to-peer sharing of app download links, which can boost a

### SUMMARY

The invention provides systems and methods to incentivize mobile application downloads though in-app contests and/or promotions (hereafter referred to collectively as “promotions”). Various aspects of the invention described herein may be applied to any of the particular applications set forth below. The invention may be applied as a standalone system or as a component of an integrated software solution within a mobile app or as a modular Software Development Kit (“SDK”) to be integrated into a mobile application. The invention can be optionally integrated into existing business and social networking processes seamlessly. It shall be understood that different aspects of the invention can be appreciated individually, collectively or in combination with each other.

The present disclosure provides systems and methods that incentivize the sharing of mobile applications among users. In an aspect, a method for incentivizing the sharing of a mobile application comprises providing, on a user interface of a mobile application executed on a first mobile electronic device of a first user, an offer for a promotion, which promotion is accessible by the first user when the first user elects to share the mobile application with at least one second user having a second mobile electronic device. For example, the first user can accept the offer for the promotion by electing to share the mobile application with the second user. Next, a request from the first user to share the mobile application with the second user is received. Next, an electronic communication is directed from the first mobile electronic device to the second user (e.g., to the second mobile electronic device or another electronic device of the second user), which electronic communication has an electronic link that enables the second user to download a copy of the mobile application onto the second mobile electronic device. The electronic communication can be directed from the first mobile electronic device to the second mobile electronic device directly or through a computer system (e.g., server) that is programmed to incentivize the sharing of mobile applications. Next, the first user is provided with the promotion. In some cases, the first user is provided with the promotion upon receiving an indication that the mobile application has been shared by the first user with the second user.

In another aspect, a method of creating a promotion to aid in incentivizing the sharing of an app download link is provided. The method includes steps of creating a promotion using an admin panel interface, which allows an “administrative user” (e.g., a user who is responsible for managing content within the mobile app) to upload one or more images, enter descriptive information on the promotion, choose a termination date, send push notifications to users of the mobile app, and display the promotion information to the app users.

In another aspect, a method for distributing the promotion information and associated push notifications is provided. The method includes a processor embodying logic for distribution of promotion information and mobile push notifications, which comprises at least one sequence of instructions, wherein execution of the instructions by a processor causes the processor to perform the acts described in the preceding paragraph.

In another aspect, a method of incentivized peer-to-peer sharing of the mobile app download link is provided. The method includes steps of receiving the promotion information in the mobile app, receiving instructions stating that qualifying for the promotion requires sharing of the app download link, selecting a medium of sharing for the app download link by text, social network post, email or other electronic communication method, performing the sharing function, and then having the sharing recorded for reporting purposes.

In another aspect, a method for sharing the app download link is provided. The method includes a processor embodying logic for distribution of the download link through various approaches and the subsequent recording and reporting of that user action, which comprises at least one sequence of instructions, wherein execution of the instructions by a processor causes the processor to perform the acts described in the preceding paragraph.

Another aspect of the present disclosure provides a computer readable medium comprising machine executable code that, upon execution by one or more computer processors, implements any of the methods above or elsewhere herein.

Another aspect of the present disclosure provides a computer system comprising one or more computer processors and memory coupled to the one or more computer processors. The memory comprises machine executable code that, upon execution by the one or more computer processors, implements any of the methods above or elsewhere herein.

Unless specifically stated otherwise, as apparent from the following discussions, it is appreciated that throughout the specification, discussions utilizing terms such as “processing,” “computing,” “calculating,” “determining,” or the like, may refer in whole or in part to the action and/or processes of a processor, computer or computing system, or similar electronic computing device, that manipulate and/or transform data represented as physical, such as electronic, quantities within the system's registers and/or memories into other data similarly represented as physical quantities within the system's memories, registers or other such information storage, transmission or display devices. It will also be appreciated by persons skilled in the art that the terms “administrative users” and “app users” referred to herein can be individuals as well as corporations and other legal entities. Furthermore, the processes presented herein are not inherently related to any particular computer, processing device, article or other apparatus. An example of a structure for a variety of these systems will appear from the description below. In addition, embodiments of the present invention are not described with reference to any particular processor, programming language, machine code, etc. It will be appreciated that a variety of programming languages, machine codes, etc. may be used to implement the teachings of the invention as described herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 illustrates an example environment 100 for generating an incentivized peer-to-peer sharing of application (“app”) download links using an in-app promotions system.

FIG. 2 is a block diagram of administrative storage and interface modules of an incentivized app download promotion.

FIG. 3 is a block diagram of mobile apps installed on an app user's mobile phone, which can be linked via Application Programming Interfaces (API) to aid in the peer-to-peer sharing of app download links using an in-app promotions system.

FIG. 4 is a block diagram of in-app promotions modules within an app using the incentivized promotions system.

FIG. 5 is a block diagram of in-app promotions interface modules within an in-app promotions interface.

FIG. 6 illustrates an environment for selecting peers from an app user's mobile phone book to enable sharing of app download links via text message.

FIG. 7 illustrates an environment for selecting peers from an app user's mobile phone book to enable sharing of app download links via email.

FIG. 8 illustrates an environment for sharing app download links with peers via social network APIs.

FIG. 9 illustrates an environment for reporting actions of users who qualify for the promotion by sharing app download links with peers.

FIG. 10 illustrates a screenshot of an administrative interface.

FIG. 11 illustrates screen shots of the receiving mobile app, push notification display, graphic notification and mobile promotions interface.

FIG. 12 illustrates additional screen shots of a mobile promotions interface and also illustrates a transition flow between a front page of the mobile promotions interface and the contact selection page.

FIG. 13 illustrates a screen shot of a text message app and also illustrates an exemplary transition flow between the contact selection page of a mobile promotions interface and the text message app.

FIG. 14 illustrates a screen shot of social network share buttons and also illustrates an exemplary transition flow between a text message app and a screen within a mobile promotions interface.

FIG. 15 illustrates a screen shot of a promotions reporting engine output.

FIG. 16 shows a computer system that is programmed or otherwise configured to implement methods herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The present disclosure relates generally to the creation, transmission, presentation and sharing of an incentivized promotion that can be used to increase peer-to-peer sharing of mobile application (“app”) download links. The present disclosure also provides systems and methods for the creation and transmission of a promotion, which can incentivize peer-to-peer sharing of mobile app download links.

The term “promotion,” as used herein, generally refers to an item or activity that supports or provides, or is intended to support or provide, active encouragement for the furtherance of a cause, venture, or aim. A promotion can be a free or discounted item, such as, for example, a free flight to a given destination. A promotion can be provided in exchange for a given action from a user.

The present disclosure provides systems and methods that incentivize the sharing of mobile applications among users. In an aspect, a method for incentivizing the sharing of a mobile application comprises providing, on a user interface of a mobile application executed on a first mobile electronic device of a first user, an offer for a promotion, which promotion is accessible by the first user when the first user elects to share the mobile application with at least one second user having a second mobile electronic device. For example, the first user can accept the offer for the promotion by electing to share the mobile application with the second user. Next, a request from the first user to share the mobile application with the second user is received. Next, an electronic communication is directed from the first mobile electronic device to the second mobile electronic device, which electronic communication has an electronic link that enables the second user to download a copy of the mobile application onto the second mobile electronic device. The electronic communication can be directed from the first mobile electronic device to the second mobile electronic device directly or through a computer system (e.g., server) that is programmed to incentivize the sharing of mobile applications. Next, the first user is provided with the promotion. In some cases, the first user is provided with the promotion upon receiving an indication that the mobile application has been shared by the first user with the second user.

As described herein, an incentivized promotion may be related to a contest, advertisement, game, game mechanic, etc., and may contain any type of content, as desired by the creator of the promotion or maintained by the system. An incentivized promotion may be created by an administrative user, or imported by the system from outside the system (also “system-generated promotion” herein). System-generated promotion may be generated from information obtained from third party sources or social networks. For example, system-generated promotion may be generated from information from a website which sells event tickets, a website which hosts sporting events, or a group couponing website. Furthermore, an incentivized promotion to increase peer-to-peer sharing of mobile app download links may be coupled with a non-incentivized promotion of a different type. For example, a group couponing app may offer a non-incentivized promoted deal on the purchase of heated gloves, which is coupled with an incentivized 2-for-1 offer if that user shares app download links with friends.

A system and method for creating a promotion to aid in incentivizing the sharing of an app download link are provided. An administrative user who wishes to create this promotion can interact with an administrative interface, such as a user interface (e.g., graphical user interface), which controls the transmission and display of the promoted content for a given set of mobile app users. A set of mobile app users may be a segment of a population of users for a given mobile app, or the entire population of users for a given mobile app. The administrative user may use the admin panel to upload one or more images for the promotion, which will be transmitted and displayed within a promotions interface within the given set of mobile apps. The administrative user may also use the admin panel to enter descriptive written content for the promotion, along with an expiration date for the promotion. For example, the administrative user can enter “We're giving away two tickets to Fiji! Share our app with friends for a chance to win” along with an uploaded picture of a beach in Fiji. The administrative user may opt to send a push notification from the admin panel to the given set of mobile app users, or the push notification may be sent automatically upon the entering of the promotional content within the admin panel.

Upon the administrative user submitting the promotion through the admin panel, receiving mobile app users can receive push notifications notifying them of the promotion. App users can also see a promotions banner within the receiving mobile app regarding the promotion. The method of conveying the promotion information to mobile app users is not restricted to push notifications and/or in-app banners; other methods of notifying a mobile app user may be employed including other visual elements within the receiving mobile app, emails sent to the mobile app users, etc. Mobile app users may review the promotional content within an interface in the receiving mobile apps, with a directive to share the mobile app download link(s) with peers to qualify for the promotion.

The process of qualifying for a promotion requires an app user to share the mobile download links with peers through various approaches. One peer-sharing method involves the receiving mobile app user to use the in-app promotions interface to initiate sharing of the mobile app download links by selecting contacts (peers) from their mobile phonebook, which the promotions interface accesses through the native phonebook application programming interface (“API”). The API allows the promotions interface to access to the mobile app users' contacts' phone numbers and email addresses stored within the users' native mobile phonebook. Once the mobile app user selects contacts from the in-app promotions interface, the interface may programmatically access the phone's text message and/or email application(s) through available APIs in efforts to auto-populate text messages and/or emails to selected contacts with the mobile app, such messages to contain download links and information about the promotion. Another peer-sharing method may involve the app user initiating sharing through available social network APIs, which allow for the in-app promotions interface to pre-populate messages containing the mobile-app download links and information about the promotion in efforts to allow posting to the mobile app users' social network accounts and/or in efforts to send those messages to peers (friends or followers) and contacts within those accounts. Other methods may involve the sharing of download links through other APIs, which allow access to other third-party services not fully described here. All sharing methods contain reporting for the administrative user, which allows the administrative user to identify which app users performed the peer-sharing of download links. Such reporting may display app users' app usage data and personally identifiable data such as names, email address and other information. These functions are all described in more detail below.

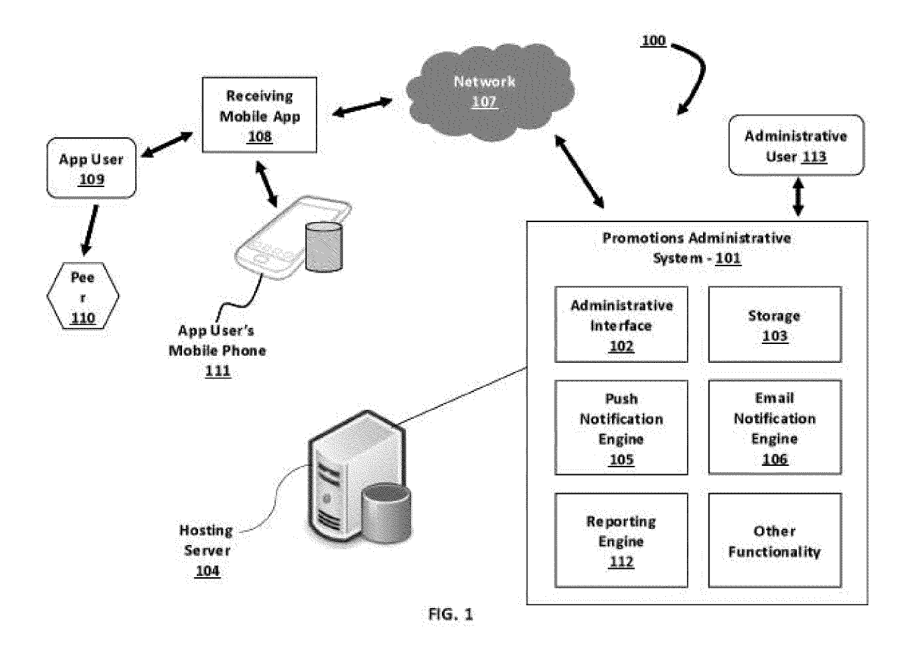

FIG. 1 illustrates an exemplary environment 100 for generating incentivized peer-to-peer sharing of app download links to using an in-app promotions system. One or more users, such as user 109 on receiving mobile app 108, are coupled to promotions administrative system 101 via a network 107. In some embodiments a single receiving mobile app 108 may have an unlimited number of downloaded copies, each of which belongs to a different app user 109 of the receiving app 108. The promotions administrative system 101 may be configured for any entity, which owns or administers copies of a single receiving mobile app, or various receiving mobile apps 108 and their associated copies. For instance, one promotions administrative system 101 may be coupled to receiving mobile apps 108 of different names and types, each of which has associated copies that run the same incentivized downloads promotion from a single promotion administrative system 101. In some embodiments a single promotions administrative system 101 may be coupled to a segmented group of app-users 109 on copies of a single receiving mobile app 108. A segmented group according to one embodiment is a separate group of copies, of which may have app users 109 with certain unique qualities, such as a segment of female-only users, a segment of users who like electronic music, a segment of users who reside in a specific geographic area, etc.

The promotions administrative system 101 may include functions and capabilities such as an administrative interface 102, storage 103, push notification engine 105, email notification engine 106, reporting engine 112, each further described below, or other functionality. The promotions administrative system 101 may be coupled to a hosting server and database 104 which can store the incentivized promotions information and run the various engines. The hosting server and database 104 may be dedicated or virtualized, remotely hosted or hosted in-house, or hosted by a non-related business that administers the promotions as part of a Software as a Service offering.

As shown in FIG. 1, an administrative interface 102 is coupled to the promotions administrative system 101. The administrative interface 102 allows the administrator of receiving mobile app 108 to enter information to initiate an incentivized download promotion. Such information may include images, descriptive text, a link that allows for downloading copies of the receiving mobile app 108 in an app store, a promotions end-date, features that allow for segmentation of users on copies of a receiving mobile app 108, features that allow the same promotion to run on various different receiving mobile apps 108, or other functionality. The administrative interface 102 may be accessed through a web browser, mobile app interface, or other interface. It is appreciated that number of ways the administrative interface 102 may be accessed is not limited to the specific examples discussed herein. The administrative interface 102 may allow access to multiple administrators of the receiving mobile app 108.

The promotions administrative system 101 is coupled to a storage 103 module. The promotions administrative system 101 can maintain a database for the receiving mobile app 108 identification numbers and associated user information, which allows the promotions administrative interface 101 in to properly identify which receiving mobile apps 108 are to be included in an incentivized promotion. The storage 103 module can also contain a database to store the promotions information, receiving mobile app 108 download link(s), images, dates and other information.

The promotions administrative system 101 is coupled to a push notification engine 105. The administrator of the receiving mobile app 108 can send a push notification to the receiving mobile app 108, or a segment of copies of the receiving mobile app 108, announcing the new incentivized promotion. For instance, the administrator can be running a contest for a travel ticket giveaway and entered information into the promotions administrative system 101 as “We're giving away two tickets to Fiji! Share our app for a chance to win,” which could generate a push notification to the receiving mobile app 108 saying the same. The push notification engine 105 may automatically generate push notifications with pre-populated information, or the administrator may opt to send manually, or no push notification may be generated at all.

The promotions administrative system 101 is coupled to an email notification engine 106. The administrator of the receiving mobile app 108 can send an email to the app users 109 of the receiving mobile app 108, or a segment of app users 109 of the receiving mobile app 108, announcing the new incentivized promotion. For instance, the administrator can be running a contest for a travel ticket giveaway and entered information into the promotions administrative system 101 as “We're giving away two tickets to Fiji! Share our app for a chance to win,” which could generate an email to the app users 109 of receiving mobile app 108 saying the same. The email notification engine 106 may automatically generate emails with pre-populated information, or the administrator may opt to send manually, or no emails may be generated at all.

The promotions administrative system 101 is coupled to a reporting engine 112. App users 109 qualify for promotions by sharing receiving mobile app 108 download links with peers. Peer sharing can be performed by text message, email, social network post, or other electronic approaches, which may be recorded by the reporting engine 112. The reporting engine 112 may deliver this information to the administrator via a coupling with the administrative interface 102, or through the output of reports in other formats such as Microsoft Excel, comma delimited files or other approaches. The reporting engine 112 allows the administrative user 113 to identify which app users 109 performed the peer 110 sharing of download links. Such reporting may display app users' 109 app usage data and personally identifiable data such as name, email address and other information.

A receiving mobile app 108 that has the promotions software installed is coupled to the network 107. The receiving app 108 may transmit data back and forth to the promotions administrative system 101 through the network 107. The receiving mobile app 108 is also coupled to the app user's mobile phone 111. The receiving app 108 may transmit data back and forth to the app user's mobile phone 111 through APIs made available by the app user's mobile phone 111.

App user 109 receives incentivized promotion information from the receiving app 108, and may qualify for the incentivized promotion by attempting to share the app download link(s) with one of more peers 110. The sharing of app download links may happen by text message, email, social network posting or other forms of electronic communication.

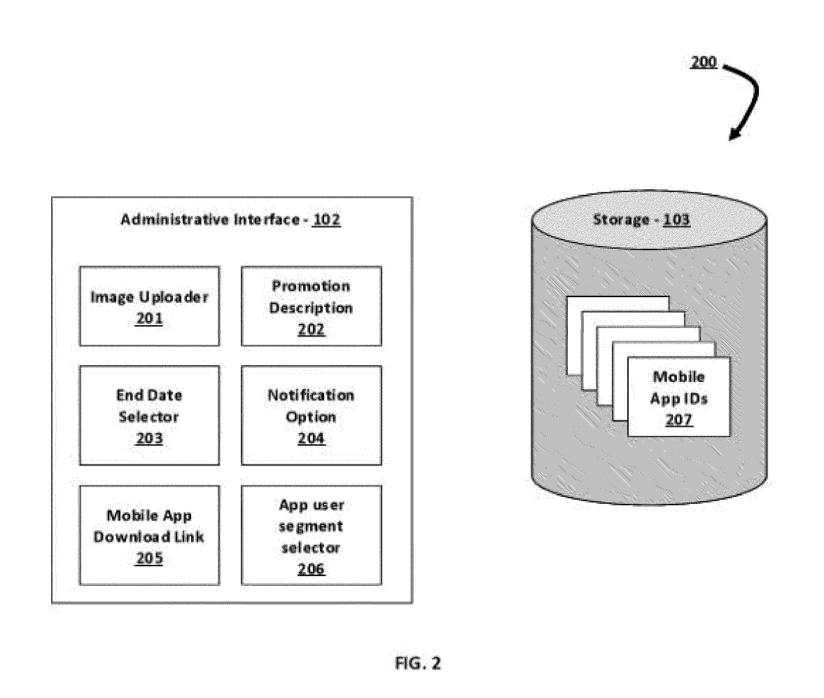

Referring now to FIG. 2, a block diagram of administrative interface 102 and storage 103 of an exemplary promotions administrative system 101 shown in FIG. 1, is shown. The administrative interface 102 may include an image uploader 201 for storing one or more images associated with the incentivized promotion.

The administrative interface 102 may also include a promotion description 202 for an incentivized promotion. Such promotion description 202 may contain pre-populated text. For instance, the promotion description may be pre-populated with “We're giving away ______. Share our app for a chance to win,” whereby the administrative user 113 needs only to populate the giveaway item. In other cases the promotion description 102 may not have pre-populated text.

The administrative interface 102 may also include an end-date selector, 203 for an incentivized promotion. The end date selector 203 allows the administrative user 113 to choose a promotion termination date, after which no app user 109 may qualify for the promotion.

The administrative interface 102 may also include a notification option 204 for an incentivized promotion. The notification option 204 allows the administrative user 113 to configure the type of notification they wish to send with an incentivized download promotion. Such notification can include push notification, email notification, or other types of electronic notifications.

The administrative interface 102 may also include a mobile app download link 205 for an incentivized promotion. The mobile app download link 205 is an app store link, which allows for the download of the receiving mobile app 108 from one or more app stores. The app user 109 can initiate sharing of the app download link 205 in order to qualify for the incentivized promotion. For instance, an app user 109 may qualify to win two tickets to Fiji by selecting peers from the phone book within the app user's mobile phone 111 with the intention of sharing a download link for the receiving mobile app 108.

The administrative interface 102 may also include an app user segment selector 206 for an incentivized promotion. The administrative user 113 may wish to isolate a certain segment of app users 109 within a receiving mobile app 108, or a certain segment of app users 109 within various receiving apps 108, which are connected to a promotions administrative system 101. In such case, the administrative user 113 can choose app user 109 segments using the segment selector 206, which references mobile app IDs (identification numbers) 207 in order to assign the incentivized promotion to the appropriate segment(s). For example, an administrative user 113 may wish to segment app users 109 who are female and reside in Chicago.

Fewer or more components may comprise the administrative interface 102 or components of the administrative interface 102 and still fall within the scope of the various embodiments.

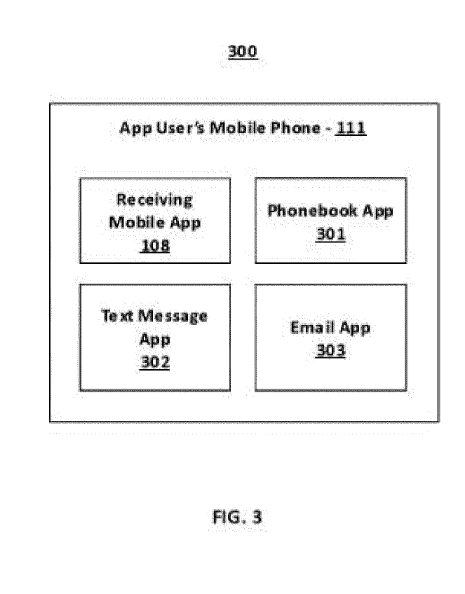

Referring now to FIG. 3, a block diagram of an app user's mobile phone 111 is shown. The app user's mobile phone 111 may include the receiving app 108. The receiving app 108 is able to connect with the network 107 because the incentivized promotions software code has been installed within the app. The incentivized promotions software code can be written as part of the app's software code base, or installed as a modular software development kit (“SDK”), written outside of the app's software code base. For example, a mobile game developer may want to install the incentivized promotions SDK, which then connects the app to a promotions administrative system 101. The developer can then use the promotions administrative system 101 to grow downloads by running incentivized peer-to-peer download link sharing promotions.

The app user's mobile phone 111 may also include a phonebook app 301, from which an exemplary user can enter and view contact information for peers such as name, email address, phone numbers, physical address and other personal information. The phonebook app 301 may have an accessible application programming interface (“API”), which provides the app user 109 with an opportunity to access the contacts' personal information from within the receiving app 108.

The app user's mobile phone 111 may also include a text messaging app 302, from which an exemplary user can send and receive text messages. The text messaging app 302 may have an API, which provides the receiving mobile app 108 an opportunity to pre-populate peers selected from the phonebook app 301 and system-created text messages, which include a mobile app download link 205. For example, the app user 109 may see an incentivized promotion such as “We're giving away two tickets to Fiji! Share our app with friends for a chance to win” in a receiving app 108. The app user 109 may then select contacts (peers) generated from the phonebook app 301 API and prepopulate the phone numbers of those contacts, along with a pre-populated text message within the text message app 302 using the text message app 302 API. In some embodiments, the text message app 302 may be a separate app from the receiving mobile app 108, in other embodiments the text message app 302 may be an integrated component of the receiving mobile app, and in yet other embodiments the text message app 302 may be a virtualized component which is handled by a third-party such as Twilio.

The app user's mobile phone 111 may also include an email app 303, from which an exemplary user can send and receive email messages. The email app 303 may have an API, which provides the receiving mobile app 108 an opportunity to pre-populate peers selected from the phonebook app 301 and system-created email messages, which include a mobile app download link 205. For example, the app user 109 may see an incentivized promotion such as “We're giving away two tickets to Fiji! Share our app with friends for a chance to win” in a receiving app 108. The app user 109 may then select contacts (peers) generated from the phonebook app 301 API and prepopulate the email addresses of those contacts, along with a pre-populated email message within the email app 303 using the email app 303 API. In some embodiments, the email app 303 may be a separate app from the receiving mobile app 108, in other embodiments the email app 303 may be an integrated component of the receiving mobile app, and in yet other embodiments the email app 303 may be a virtualized component which is handled by a third-party.

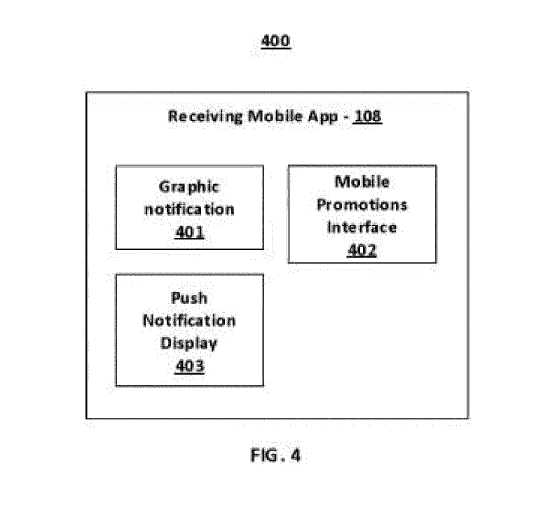

Referring now to FIG. 4, a block diagram of a receiving mobile app 108 is shown. The receiving mobile app 108 may include a graphic notification 401. The graphic notification 401 automatically appears within an exemplary receiving app 108 when a promotion has been activated in the promotions administrative system 101. The graphic notification 401 may be an image, text or combination thereof. For instance, an administrative user 113 may initiate a contest-based promotion via the promotions administrative system 101, which may then cause a graphic banner that says “Play our latest contest” to appear within a receiving app 108. The promotions graphic may be dismissed at the app user's 109 discretion.

The receiving mobile app 108 may also include a mobile promotions interface 402, from which an exemplary app user 109 can discover details about the promotion, view images and understand how to qualify for the incentivized promotion based on information submitted by an administrative user 113 in the promotions administrative system 101. The app user 109 can also use the mobile promotions interface to qualify for the promotion if desired. These functions are all described in more detail below.

The receiving mobile app 108 may also include a push notification display 403, from which an exemplary app user 109 can be notified when a new promotion has been initiated. The push notification display is coupled to the push notification engine 105, and activated when an administrative user 113 elects to send a push notification through the promotions administrative interface 101, or if the system automatically generates a push notification upon the activation of an incentivized promotion. The app user 108 may view the mobile promotions interface 402 by accessing it through the push notification display 403.

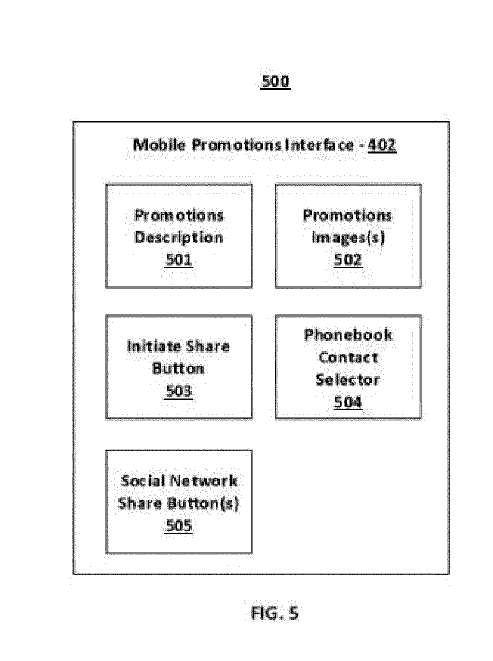

Referring now to FIG. 5, a block diagram of a mobile promotions interface 402 is shown. The mobile promotions interface 402 may contain a promotion description 501, which displays information about the promotion entered via the promotions administrative system 101, and the requisite details on how an app user 109 can qualify for the promotion. The promotions description 501 may be partially system generated based on configurable settings within the promotions administrative system 101. In some embodiments, the promotions description 501 may also be uploaded via third-party APIs.

In some embodiments, the mobile promotions interface 402 may also include promotions images 502, which displays images about the promotion entered via the promotions administrative system 101. In yet other embodiments, the promotions images 502 may also be uploaded via third-party APIs.

In some embodiments, the mobile promotions interface 402 may also include an initiate share button 503, the selecting of which may allow the app user 109 to progress into the share functionality. In some embodiments, the initiate share button 503 may link to a page, which displays the app user's 109 mobile contacts from the mobile contact selector 504. In other embodiments, the initiate share button 503 may link to the app user's 109 social sharing APIs such as Facebook and Twitter. In yet other embodiments, the initiate share button may link to a page that displays various sharing options.

In some embodiments, the mobile promotions interface 402 may also include a phonebook contact selector 504, which is coupled to the phonebook app 301 API. The phonebook contact selector 504 may display the app user's 109 contacts' names and phone numbers. In some embodiments, the phonebook contact selector may display other information such as email addresses or other personal information. The phonebook contact selector 504 may be coupled with the reporting engine 112, which may record the number of names selected by the app user 109. The phonebook contact selector may contain a “complete” button that completes the selection process and, in some embodiments, transmits the selected contacts and a pre-populated message with the mobile download link 205 to the text message app 302. In another embodiment, the “complete” button may transmit the selected contacts and a pre-populated message with the mobile download link 205 to the email app 303. In yet another embodiment, the “complete” button may transmit the selected contacts and a pre-populated message with the mobile app download link 205 simultaneously to both the text message app 302 and email app 303. In some embodiments, the app user 109 may qualify for the promotion by selecting the “complete” button.

The mobile promotions interface 402 may also include a social network share button 505, which may be coupled to the APIs made available by the app user's 109 chosen social networks. The social network share button 505 may initiate the transmission of a pre-populated message including the mobile app download link 205 to the app user's 109 social streams, or directly to contacts, friends or followers on the app user's 109 social networks. The social network share button 505 may be coupled with the reporting engine 112, which may record the app user's 109 submission to the social network(s) and/or the number of contacts selected by the app user 109 within the social network.

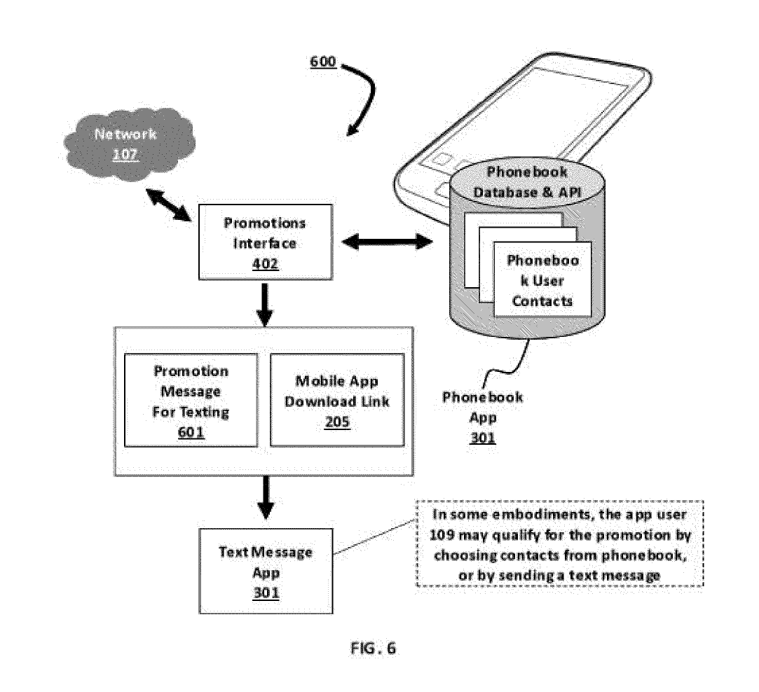

FIG. 6 illustrates an exemplary environment 600 for the process of sharing an incentivized promotion via peer-to-peer text messaging. The process includes sending a promotions message for texting 601 and mobile app download link 205 by way of using app user's mobile phone's 111 text message app 301. The promotions interface 402 may be activated with a new incentivized promotion received through the network 107. The app user 109 may view the incentivized promoted offer in the promotions interface 402, which may direct the app user 109 to qualify for the promotion by sharing the mobile app download link 205 with peers. The app user 109 may then choose to select phonebook contacts from within the promotions interface 402, which are populated from the phonebook app 301 API. Upon completing the selection of contacts, the app user 109 may direct the promotions interface 402 to populate the promotion message for texting 601 and the mobile app download link 205 within the text message app 301 via the text message app's 301 API. In some embodiments, the app user 109 may qualify for the promotion by completing the contact selection process within the promotions interface 402. In other embodiments, the app user 109 may qualify for the promotion by sending the text message to peers via the text message app 301.

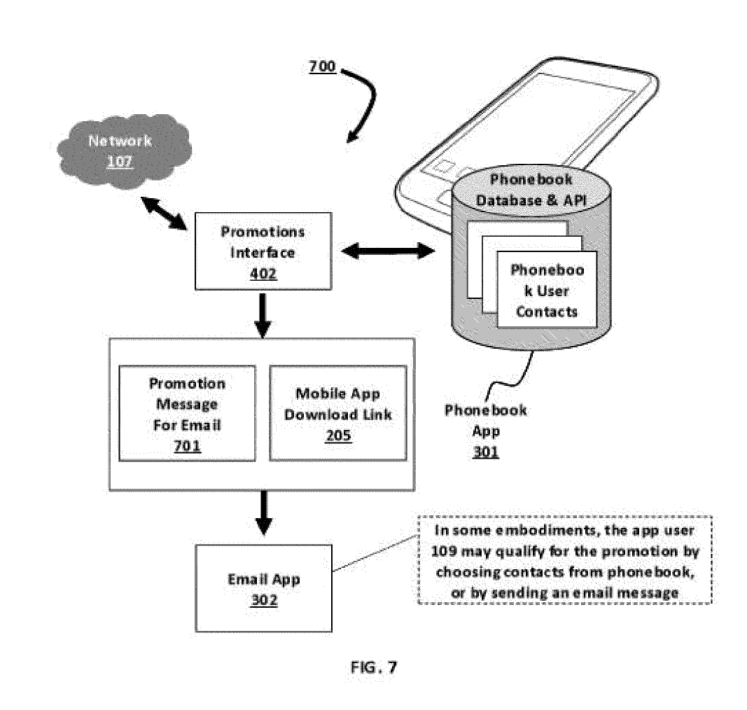

FIG. 7 illustrates an exemplary environment 700 for the process of sharing an incentivized promotion via peer-to-peer email. The process includes sending a promotions message for email 701 and mobile app download link 205 by way of using app user's mobile phone's 111 email app 302. The promotions interface 402 may be activated with a new incentivized promotion received through the network 107. The app user 109 may view the incentivized promoted offer in the promotions interface 402, which may direct the app user 109 to qualify for the promotion by sharing the mobile app download link 205 with peers. The app user 109 may then choose to select phonebook contacts from within the promotions interface 402, which are populated from the phonebook app 301 API. Upon completing the selection of contacts, the app user 109 may direct the promotions interface 402 to populate the promotion message for email 701 and the mobile app download link 205 within the email app 302 via the email app's 302 API. In some embodiments, the app user 109 may qualify for the promotion by completing the contact selection process within the promotions interface 402. In other embodiments, the app user 109 may qualify for the promotion by sending the email to peers via the email app 302.

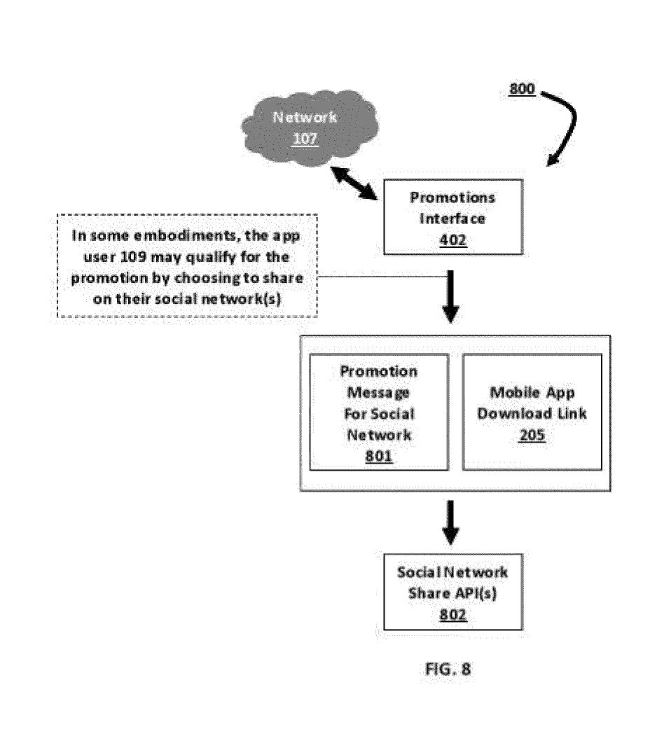

FIG. 8 illustrates an exemplary environment 800 for the process of sharing an incentivized promotion via social network post or message. The process includes sending a promotions message for social network 801 and mobile app download link 205 by way of using the app user's social network API(s) 802. The promotions interface 402 may be activated with a new incentivized promotion received through the network 107. The app user 109 may view the incentivized promoted offer in the promotions interface 402, which may direct the app user 109 to qualify for the promotion by sharing the mobile app download link 205 with peers. The app user 109 may then choose to select a social network to be shared on from within the promotions interface 402. Upon completing the selection of the social network, the app user 109 may direct the promotions interface 402 to populate the promotion message for social network 801 and the mobile app download link 205 within the social network via the social network share API(s) 802. In some embodiments, the app user 109 may qualify for the promotion by choosing to share within a social network via the promotions interface 402. In other embodiments, the app user 109 may qualify for the promotion by posting or messaging friends within the social network using the social network share API(s) 802.

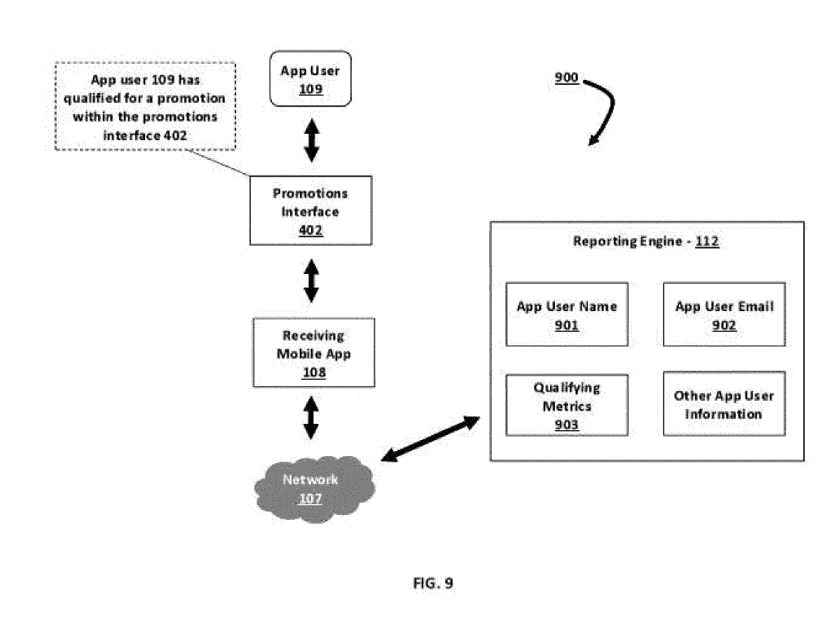

FIG. 9 illustrates an exemplary environment 900 for the process of reporting the actions of an app user 109 who has qualified for an incentivized promotion. The process includes the app user 109 qualifying for a promotion through methods described above in exemplary environments 600, 700, 800, or a combination thereof. It is appreciated that number of ways an app user 109 can qualify for a promotion is not limited to the specific examples discussed herein. In all cases the app user's 109 qualifying for the promotion is predicated on the app user 109 meeting one or more of the established qualifying metrics 903. For example, the app user may be required to share a mobile download link 205 with at least 3 contacts via text message in order to qualify for a chance to win two tickets to Fiji.

Upon the app user 109 qualifying for the promotion, the promotions interface 402 may send data regarding the app user's 109 actions, including the app user name 901, app user email 902, qualifying metrics 903 and other information about the app user 109's actions. The qualifying metrics 903 may be associated with the user sharing the mobile app download link by text message, email, social network post, or other metrics, which are established by the administrative user. Furthermore, it should be noted that the reporting engine 112 could record qualifying metrics 903, which are outside of the promotions interface. For example, an app user 109 may share a mobile app download link 205, whereby the mobile app download link is coupled with the reporting engine 112 and the qualifying metric requires the link to be “clicked”. In other embodiments, qualifying metrics 903 could be coupled with the number of mobile app download links 205 sent, or the number of mobile app download links 205 “clicked”. It is appreciated that the types of qualifying metrics 903 that can be established is not limited to the specific examples discussed herein.

The reporting engine 112 may output reports to the promotions administrative system 101, or through other forms of communication, such as electronic mail (email), Microsoft Excel, Google Docs, or other approaches. It is appreciated that the methods of delivering reports from the reporting engine 112 are not limited to the specific examples discussed herein.

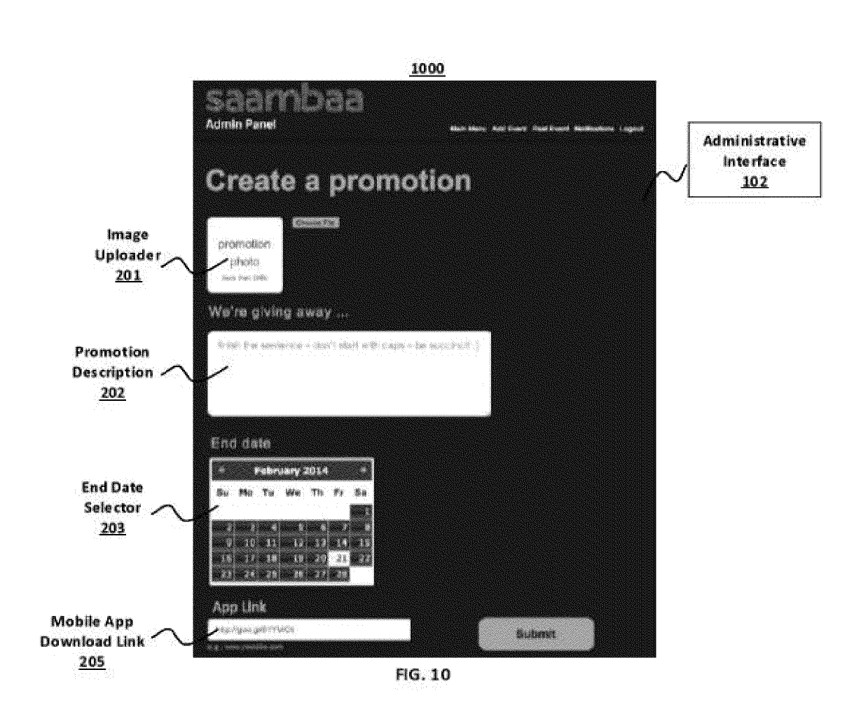

FIG. 10 illustrates an exemplary screen shot 1000 of the administrative interface 102, which contains an image uploader 201, promotion description 202, end date selector 203 and mobile app download link 205. Although not shown, the administrative interface 102 may also contain a notification option 204 and app user segment selector 206. These component functions are all described in further detail above. Fewer or more components may comprise the administrative interface 102 and still fall within the scope of the various embodiments.

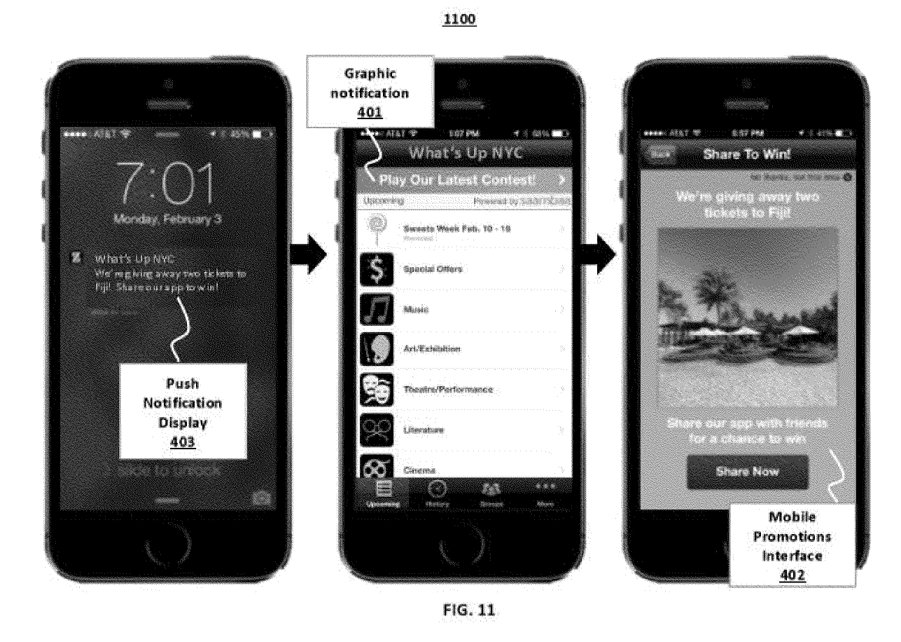

FIG. 11 illustrates exemplary screen shots 1100 of the receiving mobile app 108, which contains a push notification display 403, graphic notification 401 and mobile promotions interface 402. These component functions are all described in further detail above. Fewer or more components may comprise the receiving mobile app 108 and still fall within the scope of the various embodiments.

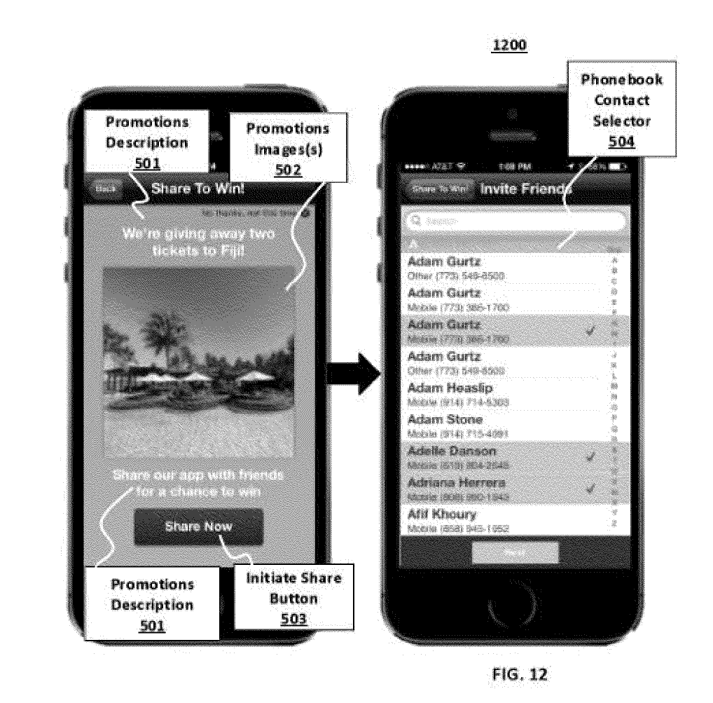

FIG. 12 illustrates additional exemplary screen shots 1200 of the mobile promotions interface 402, which contains a promotions description 501, promotions image(s) 502, initiate share button 503 and phonebook contact selector. These component functions are all described in further detail above. FIG. 12 also illustrates an exemplary transition flow between the front page of the mobile promotions interface 402 and the contact selection page, which is populated by the API from the phonebook app 301. It should be noted that the mobile promotions interface 402 may be comprised of fewer or more components and still fall within the scope of the various embodiments. In some embodiments, the mobile promotions interface 402 components may not be integrated on the same page, and may be integrated in various parts of the receiving mobile app 108.

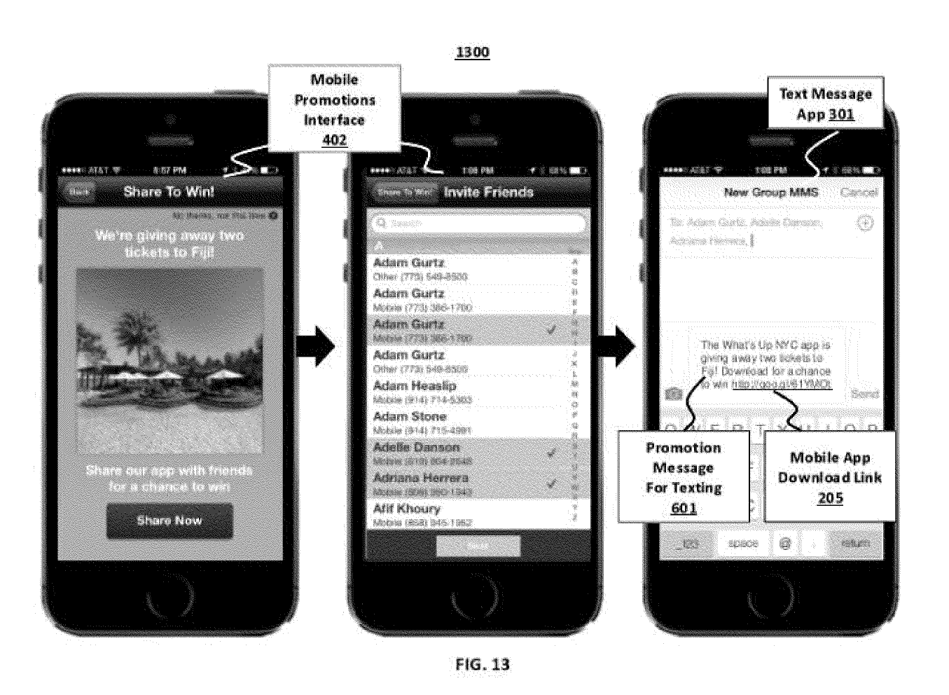

FIG. 13 illustrates an exemplary screen shot 1300 of the text message app 301, which contains the promotion message for texting 601 and mobile app download link 205. These component functions are described in further detail above. FIG. 13 also illustrates an exemplary transition flow between the contact selection page of an exemplary mobile promotions interface 402 and the text message app 301.

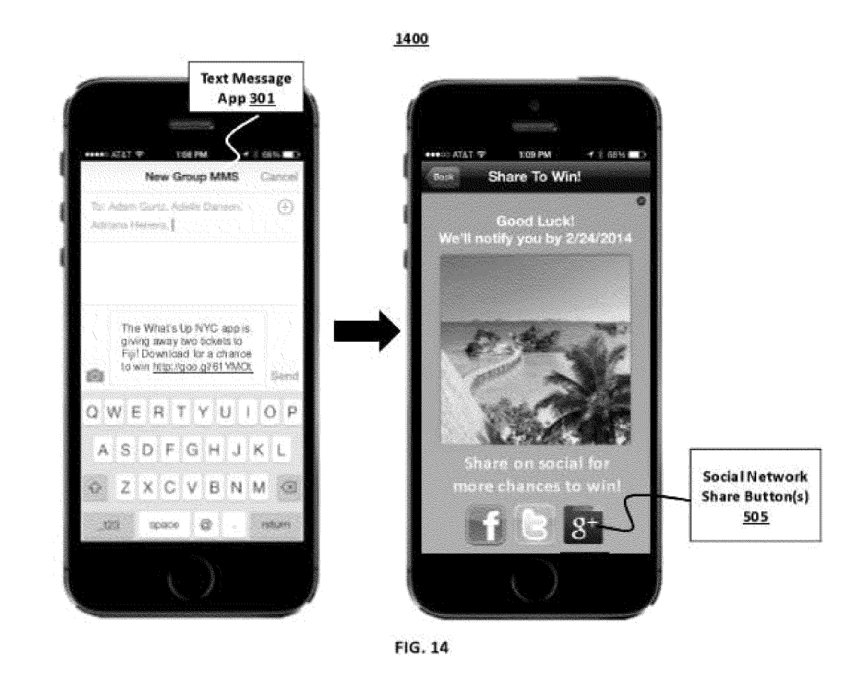

FIG. 14 illustrates an exemplary screen shot 1400 of the social network share buttons 505, which, in some embodiments are a component of the mobile promotions interface 402. These component functions are described in further detail above. FIG. 14 also illustrates an exemplary transition flow between the text message app 301 and an exemplary screen within the mobile promotions interface. In some embodiments, this transition flow can occur after an app user 109 completed the sending of the text message to peers. Fewer or more components may comprise the social network share buttons 505 and still fall within the scope of the various embodiments.

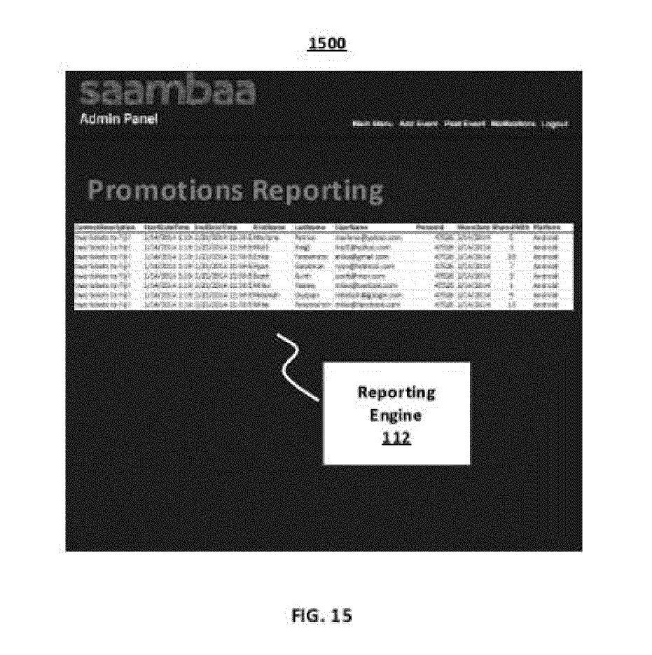

FIG. 15 illustrates an exemplary screen shot 1500 of the promotions reporting engine 112 output, which, in some embodiments is a component of the promotions administrative system 101. These component functions are described in further detail above. The reporting engine 112 may provide reports through other outputs, such as email, Microsoft Excel, Google Docs, or other approaches. It is appreciated that the methods of delivering reports from the reporting engine 112 are not limited to the specific examples discussed herein.

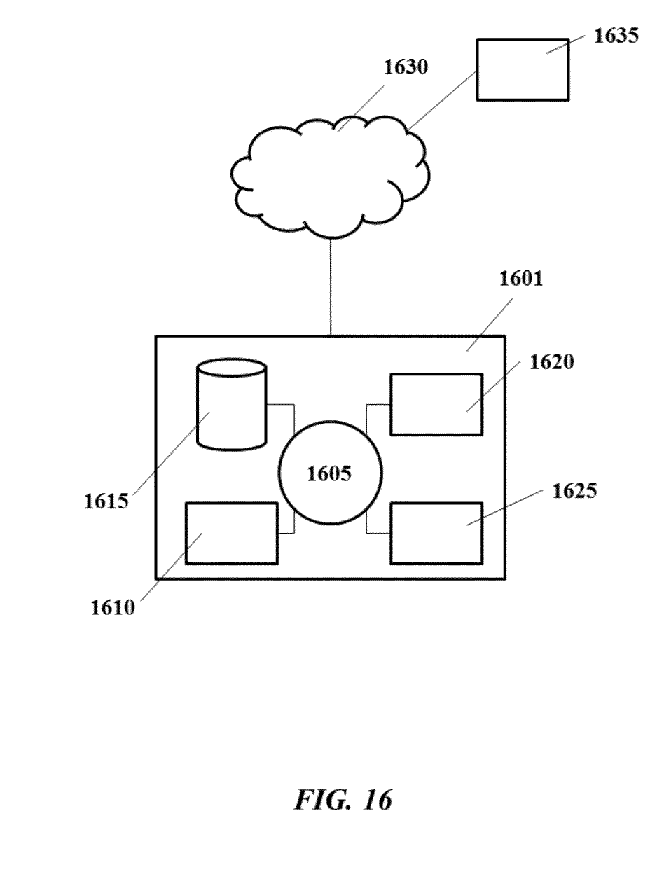

The present disclosure also provides computer systems that are programmed or otherwise configured to implement methods provided herein. FIG. 16 shows a computer system 1601 that is programmed or otherwise configured to implement methods provided herein, including generating incentivized peer-to-peer sharing of download links from within mobile applications using, for example, in-app promotions. In some examples, the computer system 1601 is a mobile (or wireless) electronic device. The computer system 1601 includes a central processing unit (CPU, also “processor” and “computer processor” herein) 1605, which can be a single core or multi core processor, or a plurality of processors for parallel processing. The computer system 1601 also includes memory or memory location 1610 (e.g., random-access memory, read-only memory, flash memory), electronic storage unit 1615 (e.g., hard disk), communication interface 1620 (e.g., network adapter) for communicating with one or more other systems, and peripheral devices 1625, such as cache, other memory, data storage and/or electronic display adapters. The memory 1610, storage unit 1615, interface 1620 and peripheral devices 1625 are in communication with the CPU 1605 through a communication bus (solid lines), such as a motherboard. The storage unit 1615 can be a data storage unit (or data repository) for storing data. The computer system 1601 can be operatively coupled to a computer network (“network”) 1630 with the aid of the communication interface 1620. The network 1630 can be the Internet, an internet and/or extranet, or an intranet and/or extranet that is in communication with the Internet. The network 1630 in some cases is a telecommunication and/or data network. The network 1630 can include one or more computer servers, which can enable distributed computing, such as cloud computing. The network 1630, in some cases with the aid of the computer system 1601, can implement a peer-to-peer network, which may enable devices coupled to the computer system 1601 to behave as a client or a server.

The CPU 1605 can execute a sequence of machine-readable instructions, which can be embodied in a program or software. The instructions may be stored in a memory location, such as the memory 1610. Examples of operations performed by the CPU 1605 can include fetch, decode, execute, and writeback.

The storage unit 1615 can store files, such as drivers, libraries and saved programs. The storage unit 1615 can store user data, e.g., user preferences and user programs. The computer system 1601 in some cases can include one or more additional data storage units that are external to the computer system 1601, such as located on a remote server that is in communication with the computer system 1601 through an intranet or the Internet.

The computer system 1601 can communicate with one or more remote computer systems through the network 1630. For instance, the computer system 1601 can communicate with a remote computer system 1635 of another user. The remote computer system 1635 can be a mobile (or wireless) electronic device. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1601 via the network 1630.

Methods as described herein can be implemented by way of machine (e.g., computer processor) executable code stored on an electronic storage location of the computer system 1601, such as, for example, on the memory 1610 or electronic storage unit 1615. The machine executable or machine readable code can be provided in the form of software. During use, the code can be executed by the processor 1605. In some cases, the code can be retrieved from the storage unit 1615 and stored on the memory 1610 for ready access by the processor 1605. In some situations, the electronic storage unit 1615 can be precluded, and machine-executable instructions are stored on memory 1610.

The code can be pre-compiled and configured for use with a machine have a processor adapted to execute the code, or can be compiled during runtime. The code can be supplied in a programming language that can be selected to enable the code to execute in a pre-compiled or as-compiled fashion.

Aspects of the systems and methods provided herein, such as the computer system 1601, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1601 can include or be in communication with an electronic display that comprises a user interface (UI) for providing, for example, screens that enable a user to share a mobile application with another user in exchange for a promotion. Examples of UI's include, without limitation, a graphical user interface (GUI) and web-based user interface.

Methods and systems of the present disclosure can be implemented by way of one or more algorithms. An algorithm can be implemented by way of software upon execution by one or more computer processors.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for incentivizing the sharing of a mobile application, comprising:
(a) providing, on a user interface of a mobile application executed on a first mobile electronic device of a first user, an offer for a promotion, which promotion is accessible by the first user when the first user elects to share the mobile application with at least one second user having a second mobile electronic device;
(b) receiving a request from the first user to share the mobile application with the second user;
(c) directing, using a computer processor, an electronic communication from the first mobile electronic device to the second user, which electronic communication has an electronic link that enables the second user to download a copy of the mobile application onto the second mobile electronic device; and
(c) providing the first user with the promotion.
